(19) United States
(12) Patent Application Publication
(10) Pub. No.: US 2007/0123227 A1
(43) Pub. Date: May 31, 2007

(54) Light spot control system and method thereof

(75) Inventors: Yi Hong, Shanghai City (CN); Tony Tsai, Taipei (TW); David Ho, Taipei (TW)

Correspondence Address: BIRCH STEWART KOLASCH & BIRCH, PO BOX 747, FALLS CHURCH, VA, 22040-0747, US

(73) Assignee: Inventec Appliances Corp.

(21) Appl. No.: 11/514,826

(22) Filed: Sep. 5, 2006

(30) Foreign Application Priority Data
Sep. 5, 2005 (TW) 94130422

(51) Int. Cl. H04Q 7/38; H04Q 7/22; H04M 3/42

(52) U.S. Cl. 455/414.1

(57) ABSTRACT

A light spot control system, using a projection light of a projection device to initiate a control of a mobile communication device, includes an I/O unit and a processing unit. The I/O unit is used to receive the projection light. The processing unit is used to provide a time value and a position value. The time value is a duration of the projection light stayed at the I/O unit, and the position value is a position of the projection light stayed at the I/O unit. When the time value meets a default value, the respective position value is used to perform the control.

### BACKGROUND OF THE INVENTION

1. Field of the Invention

The invention relates to a light spot control system and a method of the system, and more particularly to the system constructed in a mobile communication device for disable persons to operate easily the mobile communication device.

2. Description of the Prior Art

Referring to FIG. 1, a block diagram of a conventional control system for a typical mobile communication device is shown. The control system 12 applicable to the mobile communication device 11, say a mobile phone, includes an input unit 121, a processing unit 122, a program cluster 123, and an output unit 124. The input unit 121 can be a keypad which is used as a signal input interface for the mobile phone. The processing unit 122 can receive an input signal from the input unit 121, and then transfer the input signal into a respective output signal according to a system program obtained from the program cluster 123. The program cluster 123 can include a plurality of system programs for various operations of the processing unit 122. The output unit 124 can be a liquid crystal display (LCD) for imaging the output signal so as to illustrate the user of the mobile phone various operation instructions.

Referring now to FIG. 2, a flowchart of a typical control for the system of FIG. 1 is shown. In particular, the control system is used to a mobile phone. The control begins at step S21. A user of the mobile phone can use a keypad as the input unit (S22). According to input from the keypad, the input unit can generate an input signal (S23). As soon as the processing unit receives the input signal, the processing unit can obtain a respective system program from the program cluster, in which the system program is determined by judging the input signal (S24). Then, the processing unit can transform the input signal into a respective output signal according to the system program (S25). The output signal can be finally imaged on the LCD of the output unit (S26). In step S27, if a new input signal is generated from the keypad or not is determined. In the case that the answer of S27 is negative, the control is over (S28). In the case that the answer of S27 is positive, then the control goes back to process S22. Upon such an arrangement, the mobile phone can be systematically controlled.

In the art, the mobile communication device includes an input unit and an output unit as respectively operation interfaces. Generally, the input unit is a keypad or a touch screen. Yet, it is noted that either of the foregoing conventional input units is not suitable to those disable or handicapped users. For those disable, to operate the normal mobile communication device is just a dream hard to achieve. Therefore, to help the disable to utilize a modern mobile communication device initiates the development of the present invention.

### SUMMARY OF THE INVENTION

Accordingly, it is an object of the present invention to provide a light spot control system applicable to a mobile communication device.

The light spot control system, using a projection device to generate a projection light or light spot as a control to the mobile communication device, comprises at least an input/output (I/O) unit and a processing unit. The I/O unit is used to receive the projection light. The processing unit is used to provide a time counter and a position counter for generating a time value and a position value, respectively. The time and position values are respectively the duration and location that the projection light stays at the I/O unit. As the time value meets a default value, the position value is used to induce a respective control for driving the mobile communication device.

In the present invention, the light spot control method comprises steps of: defining an I/O unit for receiving a projection light to the mobile communication device, defining a processing unit for providing a time value and a position value to the mobile communication device which the time and position values are respectively the duration and location of the projection light stayed at the I/O unit, and using the position value to drive a respective control as the time value meeting a default value.

All these objects are achieved by the light spot control system and method thereof described below.

### BRIEF DESCRIPTION OF THE DRAWINGS

The present invention will now be specified with reference to its preferred embodiment illustrated in the drawings, in which:

FIG. 1 is a block diagram of a conventional mobile communication device;

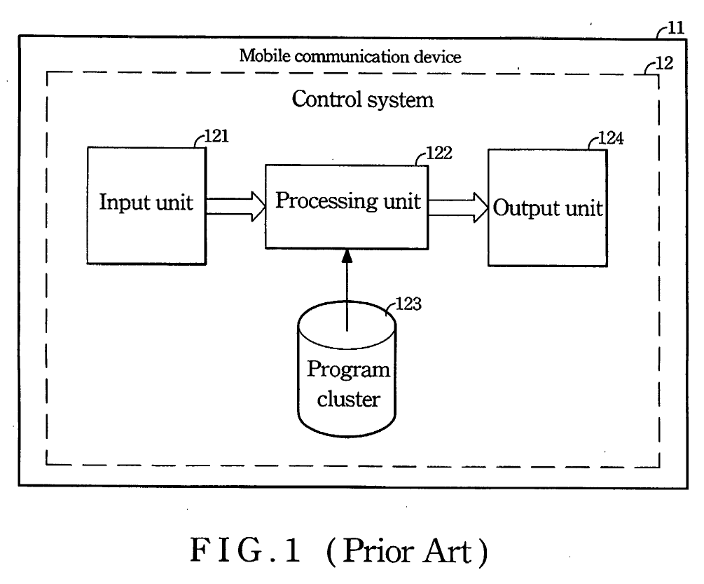

FIG. 2 is a flowchart of a typical control method for the mobile communication device of FIG. 1;

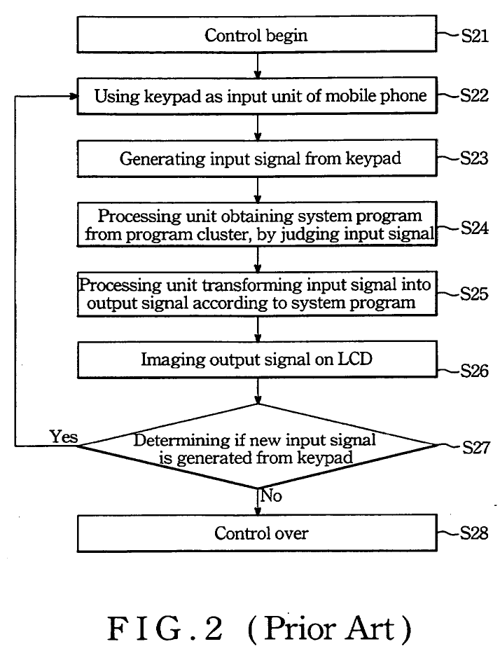

FIG. 3 is a block diagram of a preferred embodiment of the light spot control system in accordance with the present invention;

FIG. 4 shows schematically a typical application of the system of FIG. 3;

FIG. 5 shows schematically the position relationship between a user and the mobile communication device having the system of FIG. 3; and

FIG. 6 is a flowchart of a preferred embodiment of the light spot control method in accordance with the present invention.

### DESCRIPTION OF THE PREFERRED EMBODIMENT

The invention disclosed herein is directed to a light spot control system and a method of the light spot control system. In the following description, numerous details are set forth in order to provide a thorough understanding of the present invention. It will be appreciated by one skilled in the art that variations of these specific details are possible while still achieving the results of the present invention. In other instance, well-known components are not described in detail in order not to unnecessarily obscure the present invention.

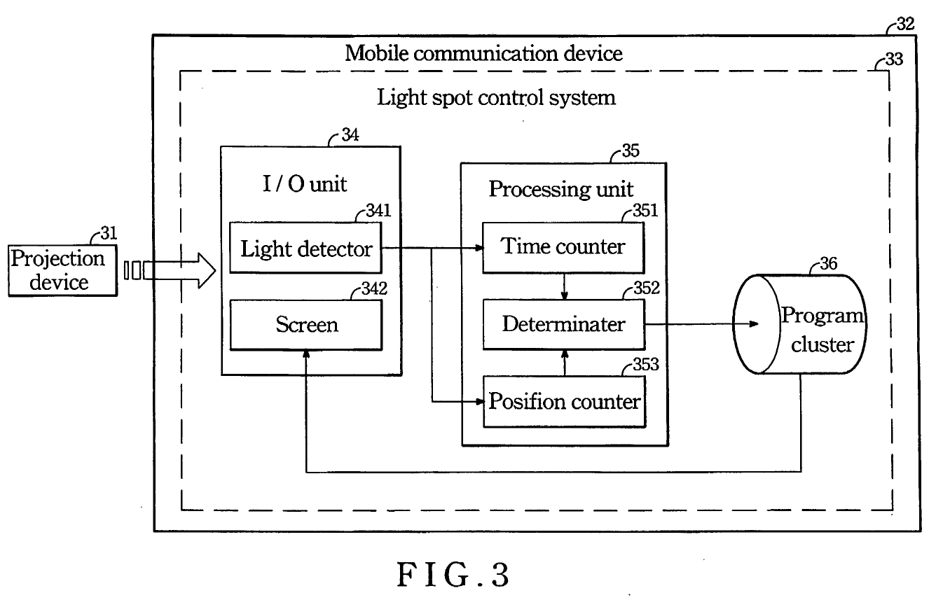

Referring now to FIG. 3, a preferred embodiment of the light spot control system in accordance with the present invention is shown. As shown, the light spot control system 33 is applied to a mobile communication device 32, which can be a mobile phone. A projection unit 31 is used to generate a projection light as a control to the mobile communication device 32. The light spot control system 33 comprises an I/O unit 34 and a processing unit 35. The I/O unit 34 can further include a light detector 341 and a screen 342 (preferably an LCD screen). The processing unit 35 can further include a time counter 351, a determinater 352 and a position counter 353. The light detector 341 of the I/O unit 34 is used to receive the projection light from the projection device 31 (to form a light spot on the I/O unit 34). The processing unit 35 utilizes the time counter 351 and the position counter 353 to provide respectively a time value and a position value. The time value is the duration of the projection light stayed at the I/O unit 34, and the position value defines the location of the I/O unit 34 where the projection light stays. As soon as the time value is increased to a default value in the determinater 352, the respective position value is used to drive a respective system program in the program cluster 36 so as to initiate a system function in the I/O unit 34 and to perform the system function on the screen 342 of the I/O unit 34.

In the present invention, the processing unit 35 can be a micro control chip.

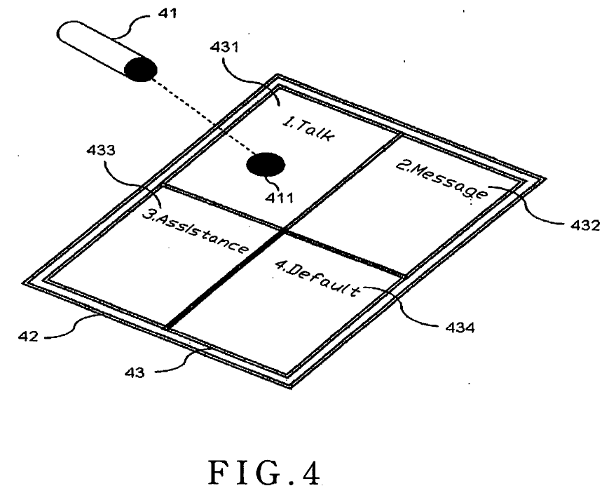

Referring now to FIG. 4, a typical application of the light spot control system of FIG. 3 is schematically shown. The spot control system is applied to a mobile phone. When a laser beam device 41 (as the projection unit) provides a laser beam 411 (as the projection light) to a LCD screen 42 of the mobile phone, the light detector 43 located under the LCD screen 42 can sense the laser beam 411 and determine the position where the laser beam 411 projects on the LCD screen 42. In particular, in the case that the light detector 43 divides functionally the LCD screen 42 into four areas of different system functions; for example as shown, a “talk” system function area 431, a “message” system function area 432, an “assistance” system function area 433, and a “default” system function area 434. In FIG. 4, the laser beam 411 is stayed in the “talk” system function area 431 and thus the mobile is activated to perform the system function of talking.

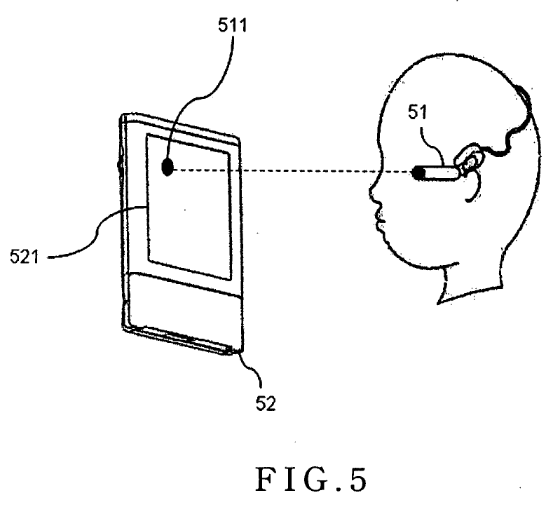

Referring now to FIG. 5, the position relationship between a user and the mobile communication device having the light spot control system of FIG. 3 is schematically shown. The spot control system is applied to a mobile phone. When a headset laser beam device 51 projects a laser beam to form a light spot 511 on the screen 521 of the mobile phone 52, the internal system of the mobile phone 52 can then perform a respective system function to the screen 521. Upon such an arrangement of the present invention, the laser beam device 51 and the light spot control system can help the disable users to operate the mobile phone 52.

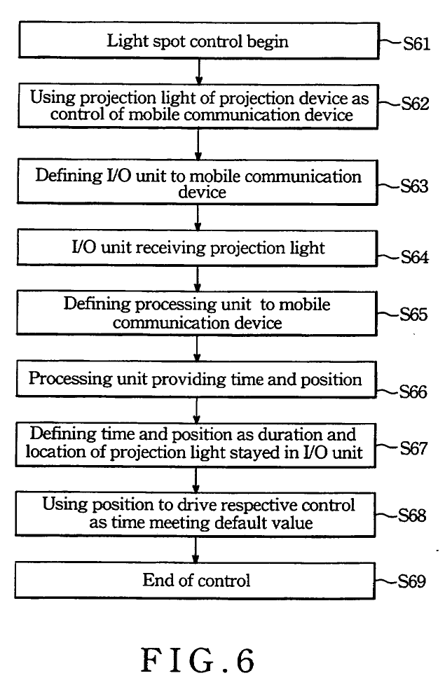

Referring now to FIG. 6, a flowchart of a preferred embodiment of the light spot control method in accordance with the present invention is shown. The light spot control method comprises steps of: beginning the control method (S61), using a projection light of a projection device for initiating a control of the mobile communication device (S62), defining an I/O unit for receiving the projection light to the mobile communication device (S63), the I/O unit receiving the projection light (S64), defining a processing unit to the mobile communication device (S65), the processing unit providing a time value and a position value to the mobile communication device (S66), defining the time and position values respectively as the duration and location of the projection light stayed at the I/O unit (S67), using the position value to drive the respective control as the time value meeting a default value (S68), and end of the light spot control method (S69).

While the present invention has been particularly shown and described with reference to a preferred embodiment, it will be understood by those skilled in the art that various changes in form and detail may be without departing from the spirit and scope of the present invention.

I claim:

1. A light spot control system for a mobile communication device, using a projection light of a projection device, comprising:
an I/O unit for receiving a projection light, the projection light used to initiate a control of the mobile communication device; and
a processing unit for providing a time value and a position value, the time value being a duration of the projection light stayed at the I/O unit, the position value being a position of the projection light stayed at the I/O unit;
wherein, when the time value meets a default value, the respective position value is used to drive the control.

2. The light spot control system according to claim 1, wherein said mobile communication device is a mobile phone.

3. The light spot control system according to claim 1, wherein said projection device is a laser beam device.

4. The light spot control system according to claim 1, wherein said projection light is a laser beam.

5. The light spot control system according to claim 1, wherein said I/O unit includes a light detector and a screen.

6. The light spot control system according to claim 1, wherein said processing unit is a micro control chip.

7. A light spot control method, applicable to a mobile communication device, using a projection light of a projection device, comprising steps of:
defining an I/O unit for receiving a projection light to the mobile communication device, the I/O unit receiving the projection light to initiate a control of the mobile communication device; and
defining a processing unit to the mobile communication device, the processing unit providing a time value and a position value, which the time value and the position value are respectively the duration and the location of the projection light stays at the I/O unit;
wherein, when the time value meets a default value, the respective position value is used to drive the control.

8. The light spot control method according to claim 7, wherein said mobile communication device is a mobile phone.

9. The light spot control method according to claim 7, wherein said projection device is a laser beam device.

10. The light spot control method according to claim 7, wherein said projection light is a laser beam.

11. The light spot control method according to claim 7, wherein said I/O unit includes a light detector and a screen.

12. The light spot control method according to claim 7, wherein said processing unit is a micro control chip.
